(19) United States
(12) Patent Application Publication
(10) Pub. No.: US 2025/0110664 A1
(43) Pub. Date: Apr. 3, 2025

(54) EFFICIENT BUS TURNAROUND FOR MEMORY CONTROLLER

(71) Applicant: Advanced Micro Devices, Inc., Santa Clara, CA (US)

(72) Inventor: Guanhao Shen, Austin, TX (US)

(73) Assignee: Advanced Micro Devices, Inc., Santa Clara, CA (US)

(21) Appl. No.: 18/374,153

(22) Filed: Sep. 28, 2023

(51) Int. Cl. G06F 3/06

(52) U.S. Cl. CPC G06F 3/0659; G06F 3/0613; G06F 3/0634; G06F 3/0679

(57) ABSTRACT

A memory controller includes a command queue for receiving memory access requests and an arbiter. The arbiter is operable to allow cross-mode activations during a streak of accesses of a current mode in response to a number of cross-mode accesses present in the command queue exceeding an adaptive threshold.

### BACKGROUND

Computer systems typically use inexpensive and high density dynamic random-access memory (DRAM) chips for main memory. Most DRAM chips sold today are compatible with various double data rate (DDR) DRAM standards promulgated by the Joint Electron Devices Engineering Council (JEDEC). DDR DRAMs use conventional DRAM memory cell arrays with high-speed access circuits to achieve high transfer rates and to improve the utilization of the memory bus.

A typical DDR memory controller maintains a queue to store pending read and write requests to allow the memory controller to pick the pending requests out of order and thereby to increase efficiency. For example, the memory controller can retrieve multiple memory access requests to the same row in a given rank of memory (referred to as “page hits”) from the queue out of order and issue them consecutively to the memory system to avoid the overhead of precharging the current row and activating another row repeatedly.

DRAM memory controllers also typically try to prioritize read accesses before write accesses to avoid stalling the host data processor while instructions or necessary data is fetched from relatively slow main memory. However, DDR memory requires significant overhead to “turn-around” from processing write accesses to processing read accesses. The loss in efficiency by turning around the bus from writes to reads and vice versa has made it difficult to provide low latency for read accesses while preserving memory controller efficiency.

### BRIEF DESCRIPTION OF THE DRAWINGS

FIG. 1 illustrates in block diagram form an accelerated processing unit (APU) and memory system known in the prior art;

FIG. 2 illustrates in block diagram form a memory controller suitable for use in an APU like that of FIG. 1 according to some implementations;

FIG. 3 illustrates a block diagram of a memory controller forming a portion of the memory controller of FIG. 2 that implements the adaptive cross-mode activation technique according to some implementations.

FIG. 4 illustrates a timing diagram 400 useful in understanding the operation of the memory controller of FIG. 3 when using adaptive cross-mode thresholding; and

FIG. 5 illustrates a flow chart useful in understanding the operation of the adaptive cross-mode memory selection technique disclosed herein according to some implementations.

In the following description, the use of the same reference numerals in different drawings indicates similar or identical items. Unless otherwise noted, the word “coupled” and its associated verb forms include both direct connection and indirect electrical connection by means known in the art, and unless otherwise noted any description of direct connection implies alternate implementations using suitable forms of indirect electrical connection as well. The following Detailed Description is directed to electrical circuitry, and the description of a block shown in a drawing figure implies the implementation of the described function using suitable electronic circuitry, unless otherwise noted.

### DETAILED DESCRIPTION OF ILLUSTRATIVE IMPLEMENTATIONS

A memory controller includes a command queue for receiving memory access requests and an arbiter. The arbiter is operable to allow cross-mode activations during a streak of accesses of a current mode in response to a number of cross-mode accesses present in the command queue exceeding an adaptive threshold.

A data processing system includes a data processor, a memory, and a memory controller coupled to the data processor and the memory. The memory controller includes a command queue for receiving memory access requests and an arbiter. The arbiter is operable to allow cross mode activations during a streak of accesses of a current mode in response to a number of cross-mode accesses present in the command queue exceeding an adaptive threshold.

A method for use in a memory controller includes selecting current-mode memory access requests from a command queue and sending them to a memory interface queue that causes them to be transmitted over a memory channel. Cross-mode activations are allowed during a streak of accesses of a current mode is made in response to a number of cross-mode accesses in the command queue exceeding an adaptive threshold.

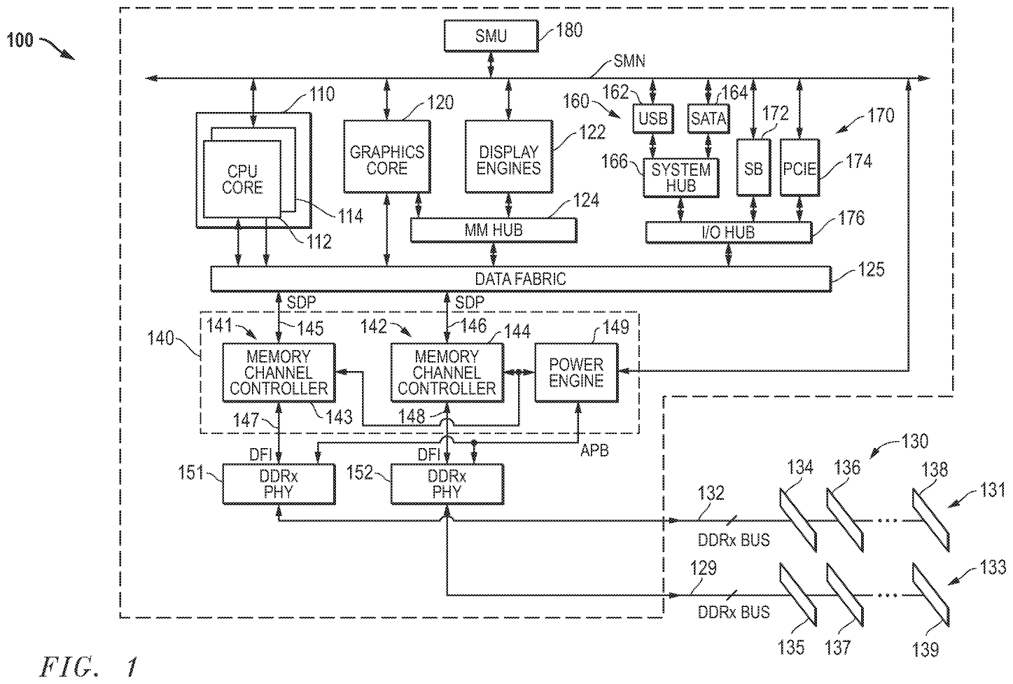

FIG. 1 illustrates in block diagram form an accelerated processing unit (APU) 100 and memory system 130 known in the prior art. APU 100 is an integrated circuit suitable for use as a processor in a host data processing system, and includes generally a central processing unit (CPU) core complex 110, a graphics core 120, a set of display engines 122, a memory controller 140, a data fabric 125, a set of peripheral controllers 160, a set of peripheral bus controllers 170, and a system management unit (SMU) 180. As will be appreciated by a person of ordinary skill, APU 100 may not have all of these elements present in every implementation and, further, may have additional elements included therein. Furthermore, APU 100 may comprise one or multiple integrated circuits in, for example, a system.

CPU core complex 110 includes a CPU core 112 and a CPU core 114. In this example, CPU core complex 110 includes two CPU cores, but in other implementations CPU core complex 110 can include an arbitrary number of CPU cores. Each of CPU cores 112 and 114 is bidirectionally connected to a system management network (SMN), which forms a control fabric, and to data fabric 125, and is capable of providing memory access requests to data fabric 125. Each of CPU cores 112 and 114 may be unitary cores, or may further be a core complex with two or more unitary cores sharing certain resources such as caches.

Graphics core 120 is a high performance graphics processing unit (GPU) capable of performing graphics operations such as vertex processing, fragment processing, shading, texture blending, and the like in a highly integrated and parallel fashion. Graphics core 120 is bidirectionally connected to the SMN and to data fabric 125, and is capable of providing memory access requests to data fabric 125. In this regard, APU 100 may either support a unified memory architecture in which CPU core complex 110 and graphics core 120 share the same memory space, or a memory architecture in which CPU core complex 110 and graphics core 120 share a portion of the memory space, while graphics core 120 also uses a private graphics memory not accessible by CPU core complex 110.

Display engines 122 render and rasterize objects generated by graphics core 120 for display on a monitor. Graphics core 120 and display engines 122 are bidirectionally connected to a common memory management hub 124 for uniform translation into appropriate addresses in memory system 130, and memory management hub 124 is bidirectionally connected to data fabric 125 for generating such memory accesses and receiving read data returned from the memory system.

Data fabric 125 includes a crossbar switch for routing memory access requests and memory responses between any memory accessing agent and memory controller 140. It also includes a system memory map, defined by basic input/output system (BIOS), for determining destinations of memory accesses based on the system configuration, as well as buffers for each virtual connection.

Peripheral controllers 160 include a universal serial bus (USB) controller 162 and a Serial Advanced Technology Attachment (SATA) interface controller 164, each of which is bidirectionally connected to a system hub 166 and to the SMN bus. These two controllers are merely exemplary of peripheral controllers that may be used in APU 100.

Peripheral bus controllers 170 include a system controller or “Southbridge” (SB) 172 and a Peripheral Component Interconnect Express (PCIe) controller 174, each of which is bidirectionally connected to an input/output (I/O) hub 176 and to the SMN bus. I/O hub 176 is also bidirectionally connected to system hub 166 and to data fabric 125. Thus, for example a CPU core can program registers in USB controller 162, SATA interface controller 164, SB 172, or PCIe controller 174 through accesses that data fabric 125 routes through I/O hub 176. Software and firmware for APU 100 are stored in a system data drive or system BIOS memory (not shown) which can be any of a variety of non-volatile memory types, such as read-only memory (ROM), flash electrically erasable programmable ROM (EEPROM), and the like. Typically, the BIOS memory is accessed through the PCIe bus, and the system data drive through the SATA interface.

SMU 180 is a local controller that controls the operation of the resources on APU 100 and synchronizes communication among them. SMU 180 manages power-up sequencing of the various processors on APU 100 and controls multiple off-chip devices via reset, enable and other signals. SMU 180 includes one or more clock sources (not shown), such as a phase locked loop (PLL), to provide clock signals for each of the components of APU 100. SMU 180 also manages power for the various processors and other functional blocks, and may receive measured power consumption values from CPU cores 112 and 114 and graphics core 120 to determine appropriate power states.

Memory controller 140 and its associated physical interfaces (PHYs) 151 and 152 are integrated with APU 100 in this implementation. Memory controller 140 includes memory channels 141 and 142 and a power engine 149. Memory channel 141 includes a host interface 145, a memory channel controller 143, and a physical interface 147. Host interface 145 bidirectionally connects memory channel controller 143 to data fabric 125 over a serial presence detect link (SDP). Physical interface 147 bidirectionally connects memory channel controller 143 to PHY 151, and conforms to the DDR PHY Interface (DFI) Specification. Memory channel 142 includes a host interface 146, a memory channel controller 144, and a physical interface 148. Host interface 146 bidirectionally connects memory channel controller 144 to data fabric 125 over another SDP. Physical interface 148 bidirectionally connects memory channel controller 144 to PHY 152, and conforms to the DFI Specification. Power engine 149 is bidirectionally connected to SMU 180 over the SMN bus, to PHYs 151 and 152 over the APB, and is also bidirectionally connected to memory channel controllers 143 and 144. PHY 151 has a bidirectional connection to memory channel 131. PHY 152 has a bidirectional connection to memory channel 133.

Memory controller 140 is an instantiation of a memory controller having two memory channel controllers and uses a shared power engine 149 to control operation of both memory channel controller 143 and memory channel controller 144 in a manner that will be described further below. Each of memory channels 141 and 142 can connect to state-of-the-art DDR memories such as DDR version four (DDR4), low power DDR4 (LPDDR4), graphics DDR version five (gDDR5), and high bandwidth memory (HBM), and can be adapted for future memory technologies. These memories provide high bus bandwidth and high speed operation. At the same time, they also provide low power modes to save power for battery-powered applications such as laptop computers, and also provide built-in thermal monitoring.

Memory system 130 includes a memory channel 131 and a memory channel 133. Memory channel 131 includes a set of dual inline memory modules (DIMMs) connected to a DDRx bus 132, including representative DIMMs 134, 136, and 138 that in this example correspond to separate ranks. Likewise, memory channel 133 includes a set of DIMMs connected to a DDRx bus 129, including representative DIMMs 135, 137, and 139.

APU 100 operates as the central processing unit (CPU) of a host data processing system and provides various buses and interfaces useful in modern computer systems. These interfaces include two double data rate (DDRx) memory channels, a PCIe root complex for connection to a PCIe link, a USB controller for connection to a USB network, and an interface to a SATA mass storage device.

APU 100 also implements various system monitoring and power saving functions. In particular one system monitoring function is thermal monitoring. For example, if APU 100 becomes hot, then SMU 180 can reduce the frequency and voltage of CPU cores 112 and 114 and/or graphics core 120. If APU 100 becomes too hot, then it can be shut down entirely. Thermal events can also be received from external sensors by SMU 180 via the SMN bus, and SMU 180 can reduce the clock frequency and/or power supply voltage in response.

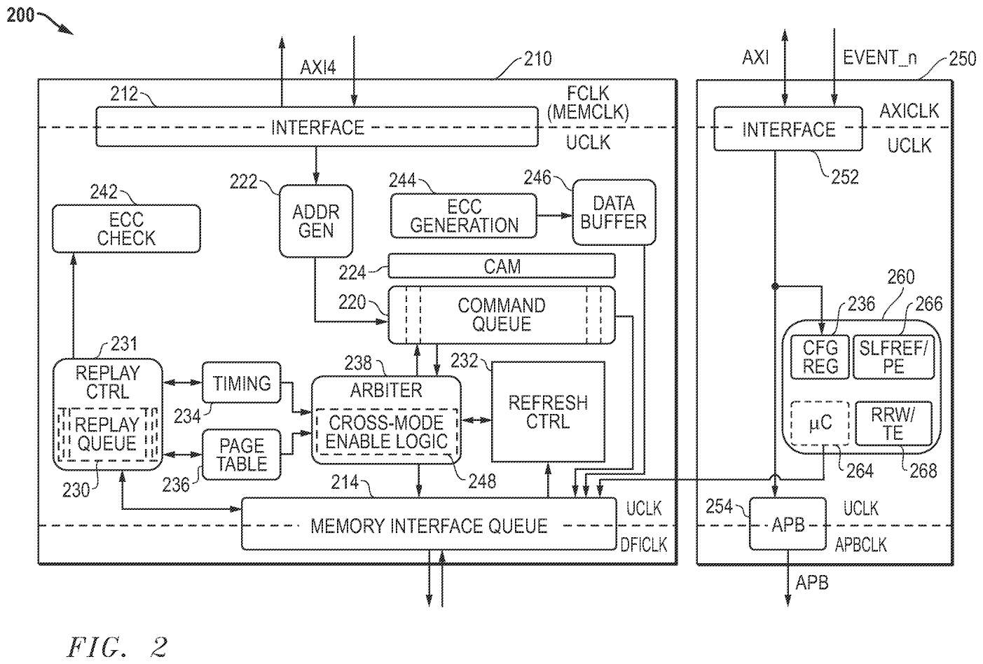

FIG. 2 illustrates in block diagram form a memory controller 200 that is suitable for use in an APU like that of FIG. 1. Memory controller 200 includes generally a memory channel controller 210 and a power controller 250. Memory channel controller 210 includes generally an interface 212, a memory interface queue 214, a command queue 220, an address generator 222, a content addressable memory (CAM) 224, replay control logic 231 including a replay queue 230, a refresh logic block 232, a timing block 234, a page table 236, an arbiter 238, an error correction code (ECC) check circuit 242, an ECC generation block 244, and a data buffer 246.

Interface 212 has a first bidirectional connection to data fabric 125 over an external bus, and has an output. In memory controller 200, this external bus is compatible with the advanced extensible interface version four, known as “AXI4”, but can be other types of interfaces in other implementations. Interface 212 translates memory access requests from a first clock domain known as the FCLK (or MEMCLK) domain to a second clock domain internal to memory controller 200 known as the UCLK domain. Similarly, memory interface queue 214 provides memory accesses from the UCLK domain to a DFICLK domain associated with the DFI interface.

Address generator 222 decodes addresses of memory access requests received from data fabric 125 over the AXI4 bus. The memory access requests include access addresses in the physical address space represented in a normalized format. Address generator 222 converts the normalized addresses into a format that can be used to address the actual memory devices in memory system 130, as well as to efficiently schedule related accesses. This format includes a region identifier that associates the memory access request with a particular rank, a row address, a column address, a bank address, and a bank group. On startup, the system BIOS queries the memory devices in memory system 130 to determine their size and configuration, and programs a set of configuration registers associated with address generator 222. Address generator 222 uses the configuration stored in the configuration registers to translate the normalized addresses into the appropriate format. Command queue 220 is a queue of memory access requests received from the memory accessing agents in APU 100, such as CPU cores 112 and 114 and graphics core 120. Command queue 220 stores the address fields decoded by address generator 222 as well other address information that allows arbiter 238 to select memory accesses efficiently, including access type and quality of service (QOS) identifiers. CAM 224 includes information to enforce ordering rules, such as write after write (WAW) and read after write (RAW) ordering rules.

Error correction code (ECC) generation block 244 determines the ECC of write data to be sent to the memory. ECC check circuit 242 checks the received ECC against the incoming ECC.

Replay queue 230 is a temporary queue for storing selected memory accesses picked by arbiter 238 that are awaiting responses, such as address and command parity responses. Replay control logic 231 accesses ECC check circuit 242 to determine whether the returned ECC is correct or indicates an error. Replay control logic 231 initiates and controls a recovery sequence in which accesses are replayed in the case of a parity or ECC error of one of these cycles. Replayed commands are placed in the memory interface queue 214.

Refresh control logic 232 includes state machines for various power down, refresh, and termination resistance (ZQ) calibration cycles that are generated separately from normal read and write memory access requests received from memory accessing agents. For example, if a memory rank is in precharge power down, it must be periodically awakened to run refresh cycles. Refresh control logic 232 generates refresh commands periodically and in response to designated conditions to prevent data errors caused by leaking of charge off storage capacitors of memory cells in DRAM chips. The memory regions are memory banks in some implementations, and memory sub-banks in other implementations as further discussed below. Refresh control logic 232 also generates refresh commands, which include both refresh (REF) commands and refresh management (RFM) commands, in which the RFM commands direct the memory to perform refresh functions for mitigating row hammer issues as further described below. In addition, refresh control logic 232 periodically calibrates ZQ to prevent mismatch in on-die termination resistance due to thermal changes in the system.

Arbiter 238 is bidirectionally connected to command queue 220 and is the heart of memory channel controller 210. Arbiter 238 improves efficiency by intelligent scheduling of accesses to improve the usage of the memory bus. Arbiter 238 uses timing block 234 to enforce proper timing relationships by determining whether certain accesses in command queue 220 are eligible for issuance based on DRAM timing parameters. For example, each DRAM has a minimum specified time between activate commands, known as “t_{RC}”. Timing block 234 maintains a set of counters that determine eligibility based on this and other timing parameters specified in the JEDEC specification, and is bidirectionally connected to replay queue 230. Page table 236 maintains state information about active pages in each bank and rank of the memory channel for arbiter 238, and is bidirectionally connected to replay queue 230. Arbiter 238 includes cross-mode enable logic 248, which maintains and adapts a cross-mode threshold in a manner that will be described further below. Arbiter 238 is bidirectionally connected to refresh control logic 232 to monitor refresh commands and direct refresh activities.

In response to write memory access requests received from interface 212, ECC generation block 244 computes an ECC according to the write data. Data buffer 246 stores the write data and ECC for received memory access requests. It outputs the combined write data/ECC to memory interface queue 214 when arbiter 238 picks the corresponding write access for dispatch to the memory channel.

Power controller 250 generally includes an interface 252 to an advanced extensible interface, version one (AXI), an advanced peripheral bus (APB) interface 254, and a power engine 260. Interface 252 has a first bidirectional connection to the SMN, which includes an input for receiving an event signal labeled “EVENT_n” shown separately in FIG. 2, and an output. APB interface 254 has an input connected to the output of interface 252, and an output for connection to a PHY over an APB. Power engine 260 has an input connected to the output of interface 252, and an output connected to an input of memory interface queue 214. Power engine 260 includes a set of configuration registers 262, a microcontroller (μC) 264, a self-refresh controller 266 labelled “SLFREF/PE”, and a reliable read/write timing engine 268 labelled “RRW/TE”. Configuration registers 262 are programmed over the AXI bus, and store configuration information to control the operation of various blocks in memory controller 200. Accordingly, configuration registers 262 have outputs connected to these blocks that are not shown in detail in FIG. 2. Self-refresh controller 266 is an engine that allows the manual generation of refreshes in addition to the automatic generation of refreshes by refresh control logic 232. Reliable read/write timing engine 268 provides a continuous memory access stream to memory or I/O devices for such purposes as DDR interface maximum read latency (MRL) training and loopback testing.

Memory channel controller 210 includes circuitry that allows it to pick memory accesses for dispatch to the associated memory channel. In order to make the desired arbitration decisions, address generator 222 decodes the address information into predecoded information including rank, row address, column address, bank address, and bank group in the memory system, and command queue 220 stores the predecoded information. Configuration registers 262 store configuration information to determine how address generator 222 decodes the received address information. Arbiter 238 uses the decoded address information, timing eligibility information indicated by timing block 234, and active page information indicated by page table 236 to efficiently schedule memory accesses while observing other criteria such as quality of service (QOS) requirements. For example, arbiter 238 implements a preference for accesses to open pages to avoid the overhead of precharge and activation commands required to change memory pages, and hides overhead accesses to one bank by interleaving them with read and write accesses to another bank. In particular during normal operation, arbiter 238 normally keeps pages open in different banks until they are required to be precharged prior to selecting a different page.

According to some implementations, arbiter 238 determines eligibility for cross-mode activate commands based adaptive thresholds kept and adapted by cross-mode enable logic 248 based on the dynamic workload as reflected in the number of read and write commands stored in command queue 220.

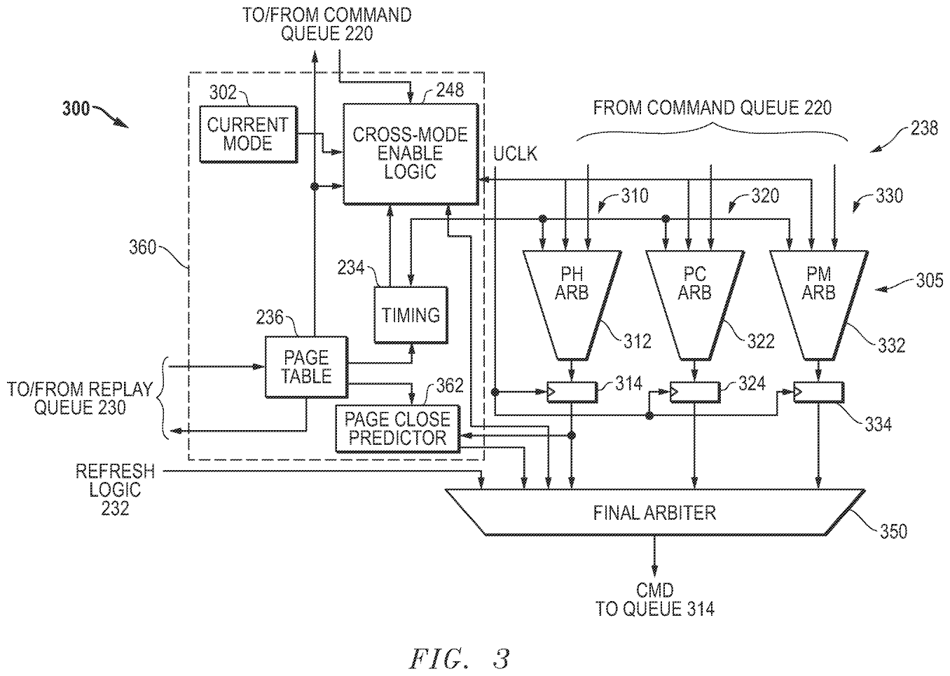

FIG. 3 illustrates a block diagram of a memory controller 300 forming a portion of memory controller 200 of FIG. 2 that implements the adaptive cross-mode activation technique according to some implementations. The adaptive cross-mode activation technique determines when to change from the current mode to the cross mode dynamically, based on the makeup of the current workload of read and write requests. The technique is adaptive because it updates its estimate of the current workload from time to time, e.g., based on the number of read and write requests in the command queue. The number of read and write requests in the command queue is variable based on the changing mix of memory access requests generated by active software threads. Memory controller 300 changes the time when it switches from the current mode to the cross mode based on an adaptive threshold, which will be explained further below.

Memory controller 300 includes arbiter 238 and a set of control circuits 360 associated with the operation of arbiter 238. Arbiter 238 includes a set of sub-arbiters 305 and a final arbiter 350. Sub-arbiters 305 include a sub-arbiter 310, a sub-arbiter 320, and a sub-arbiter 330. Sub-arbiter 310 includes a page hit arbiter 312 labeled “PH ARB” and an output register 314. Page hit arbiter 312 has a first input connected to command queue 220, a second input, and an output. Output register 314 has a data input connected to the output of page hit arbiter 312, a clock input for receiving the UCLK signal, and an output. Sub-arbiter 320 includes a page conflict arbiter 322 labeled “PC ARB” and an output register 324. Page conflict arbiter 322 has a first input connected to command queue 220, a second input, and an output. Register 324 has a data input connected to the output of page conflict arbiter 322, a clock input for receiving the UCLK signal, and an output. Sub-arbiter 330 includes a page miss arbiter 332 labeled “PM ARB” and an output register 334. Page miss arbiter 332 has a first input connected to command queue 220, a second input, and an output. Register 334 has a data input connected to the output of page miss arbiter 332, a clock input for receiving the UCLK signal, and an output. Final arbiter 350 has a first input connected to the output of refresh control logic 232, a second input from a page close predictor 362, a third input connected to the output of output register 314, a fourth input connected to the output of output register 324, a fifth input connected to the output of output register 334, and an output for providing one or more arbitration winners labelled “CMD” to queue 214.

Control circuits 360 include timing block 234, page table 236, and cross-mode enable logic 248 as previously described with respect to FIG. 2, and a page close predictor 362 and a current mode register 302. Timing block 234 has an output connected to cross-mode enable logic 248, and bidirectional connections to page hit arbiter 312, page conflict arbiter 322, and page miss arbiter 332. Page table 234 has an input connected to an output of replay queue 230, an output connected to an input of replay queue 230, an output connected to an input of command queue 220, an output connected to the input of timing block 234, and an output. Page close predictor 362 has an input connected to one output of page table 236, an input connected to the output of output register 314, and an output connected to the second input of final arbiter 350. Cross-mode enable logic 248 has an input connected to current mode register 302, and input connected to command queue 220, a bidirectional connection to final arbiter 350, and bidirectional connections to page hit arbiter 312, page conflict arbiter 322, and page miss arbiter 332.

In operation, arbiter 238 selects memory access commands from command queue 220 and refresh control logic 232 by taking into account the current mode (indicating whether a read streak or write streak is in progress), the page status of each entry, the priority of each memory access request, and the dependencies between requests. The priority is related to the quality of service or QoS of requests received from the AXI4 bus and stored in command queue 220, but can be altered based on the type of memory access and the dynamic operation of arbiter 238. Arbiter 238 includes three sub-arbiters that operate in parallel to address the mismatch between the processing and transmission limits of existing integrated circuit technology. The winners of the respective sub-arbitrations are presented to final arbiter 350. Final arbiter 350 selects between these three sub-arbitration winners as well as a refresh operation from refresh control logic 232, and may further modify a read or write command into a read or write with auto-precharge command as determined by page close predictor 362.

Each of page hit arbiter 312, page conflict arbiter 322, and page miss arbiter 332 is bidirectionally connected to the output of timing block 234 to determine timing eligibility of commands in command queue 220 that fall into these respective categories. Timing block 234 includes an array of binary counters that count durations related to the particular operations for each bank in each rank. The number of timers needed to determine the status depends on the timing parameter, the number of banks for the given memory type, and the number of ranks supported by the system on a given memory channel. The number of timing parameters that are implemented in turn depends on the type of memory implemented in the system. For example, GDDR5 memories require more timers to comply with more timing parameters than other DDRx memory types. By including an array of generic timers implemented as binary counters, timing block 234 can be scaled and reused for different memory types. The inputs from cross-mode enable logic 248 signal the sub-arbiters which type of commands, read or write, to provide as candidates for final arbiter 350.

A page hit is a read or write access to an open page. Page hit arbiter 312 arbitrates between accesses in command queue 220 to open pages. The timing eligibility parameters tracked by timers in timing block 234 and checked by page hit arbiter 312 include, for example, row address strobe (RAS) to column address strobe (CAS) delay time (t_{RCD}) and CAS latency (t_{CL}). For example, t_{RCD} specifies the minimum amount of time that must elapse before a read or write access to a page after it has been opened in a RAS cycle. Page hit arbiter 312 selects a sub-arbitration winner based on the assigned priority of the accesses. In one implementation, the priority is a 4-bit, one-hot value that therefore indicates a priority among four values, however it should be apparent that this four-level priority scheme is just one example. If page hit arbiter 312 detects two or more requests at the same priority level, then the oldest entry wins.

A page conflict is an access to one row in a bank when another row in the bank is currently activated. Page conflict arbiter 322 arbitrates between accesses in command queue 220 to pages that conflict with the page that is currently open in the corresponding bank and rank. Page conflict arbiter 322 selects a sub-arbitration winner that causes the issuance of a precharge command. The timing eligibility parameters tracked by timers in timing block 234 and checked by page conflict arbiter 322 include, for example, the active-to-precharge command period (TRAS). Page conflict arbiter 322 selects a sub-arbitration winner based on the assigned priority of the access. If page conflict arbiter 322 detects two or more requests at the same priority level, then the oldest entry wins.

A page miss is an access to a bank that is in the precharged state. Page miss arbiter 332 arbitrates between accesses in command queue 220 to precharged memory banks. The timing eligibility parameters tracked by timers in timing block 234 and checked by page miss arbiter 332 include, for example, precharge command period (t_{RP}). If there are two or more requests that are page misses at the same priority level, then the oldest entry wins.

Each sub-arbiter outputs a priority value for their respective sub-arbitration winner. Final arbiter 350 compares the priority values of the sub-arbitration winners from each of page hit arbiter 312, page conflict arbiter 322, and page miss arbiter 332. Final arbiter 350 determines the relative priority among the sub-arbitration winners by performing a set of relative priority comparisons taking into account' two sub-arbitration winners at a time. The sub-arbiters may include a set of logic for arbitrating commands for each mode, read and write, so that when the current mode changes, a set of available candidate commands are quickly available as sub-arbitration winners.

After determining the relative priority among the three sub-arbitration winners, final arbiter 350 then determines whether the sub-arbitration winners conflict (i.e., whether they are directed to the same bank and rank). When there are no such conflicts, then final arbiter 350 selects up to two sub-arbitration winners with the highest priorities. When there are conflicts, then final arbiter 350 complies with the following rules. When the priority value of the sub-arbitration winner of page hit arbiter 312 is higher than that of page conflict arbiter 322, and they are both to the same bank and rank, then final arbiter 350 selects the access indicated by page hit arbiter 312. When the priority value of the sub-arbitration winner of page conflict arbiter 322 is higher than that of page hit arbiter 312, and they are both to the same bank and rank, final arbiter 350 selects the winner based on several additional factors. In some cases, page close predictor 362 causes the page to close at the end of the access indicated by page hit arbiter 312 by setting the auto precharge attribute.

Within page hit arbiter 312, priority is initially set by the request priority from the memory accessing agent but is adjusted dynamically based on the type of accesses (read or write) and the sequence of accesses. In general, page hit arbiter 312 assigns a higher implicit priority to reads, but implements a priority elevation mechanism to ensure that writes make progress toward completion.

Whenever page hit arbiter 312 selects a read or write command, page close predictor 362 determines whether to send the command with the auto-precharge (AP) attribute or not. During a read or write cycle, the auto-precharge attribute is set with a predefined address bit and the auto-precharge attribute causes the DDR device to close the page after the read or write cycle is complete, which avoids the need for the memory controller to later send a separate precharge command for that bank. Page close predictor 362 takes into account other requests already present in command queue 220 that access the same bank as the selected command. If page close predictor 362 converts a memory access into an AP command, the next access to that page will be a page miss.

By using different sub-arbiters for different memory access types, each arbiter can be implemented with simpler logic than if it were required to arbitrate between all access types (page hits, page misses, and page conflicts; although implementations including a single arbiter are envisioned). Thus, the arbitration logic can be simplified and the size of arbiter 238 can be kept relatively small.

In other implementations, arbiter 238 could include a different number of sub-arbiters. In yet other implementations, arbiter 238 could include two or more sub-arbiters of a particular type. For example, arbiter 238 could include two or more page hit arbiters, two or more page conflict arbiters, and/or two or more page miss arbiters.

Cross-mode enable logic 248 uses adaptive thresholding to determine whether to turn around the bus from writes to reads and from reads to writes. For example, the thresholding is adaptive because it is based on the host processor's current workload measured by the number of current-mode accesses and cross-mode accesses in command queue 220. If the number of accesses in the cross-mode, i.e., the mode not currently active, stored in command queue 220 exceeds the corresponding adaptive threshold, then arbiter 238 determines to start issuing cross-mode activate commands along with “low-cost” current mode accesses, e.g., accesses that do not require sending overhead commands like precharges and activates, such as current-mode page hit accesses. When the low-cost current-mode accesses are exhausted, then arbiter 238 switches to the cross mode in which it initially only picks accesses in this mode.

According to some implementations, arbiter 238 adapts the threshold as follows. For each arbitration cycle, it takes a snapshot of the number of cross-mode accesses in the command queue, and modifies the adaptive threshold in response to the snapshot to form a next adaptive threshold. More details of the operation of the adaptive thresholding will now be further explained by using a timing diagram.

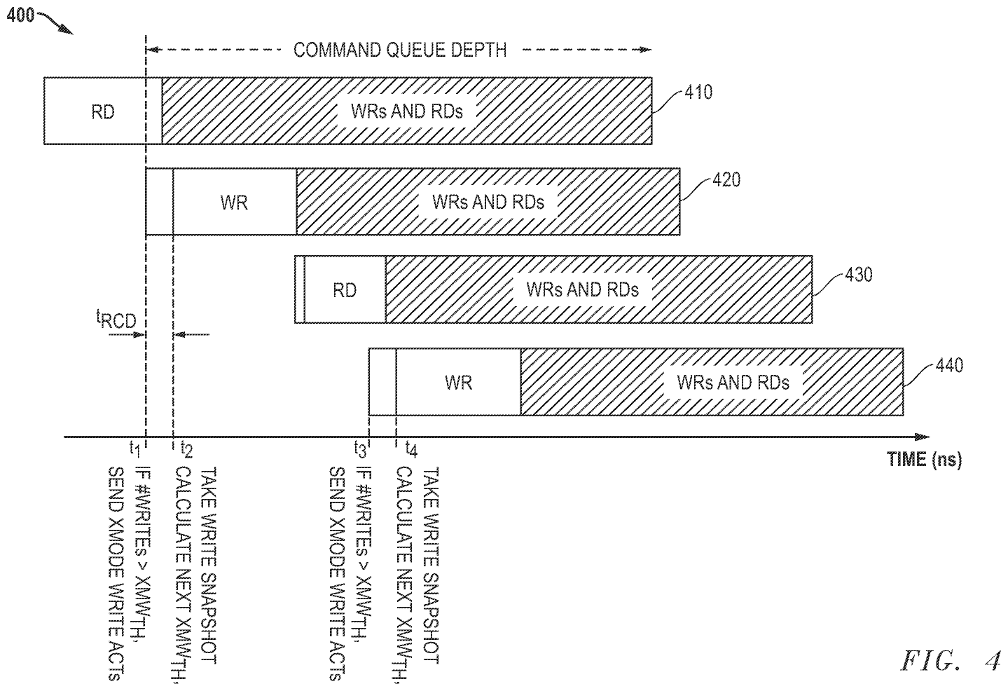

FIG. 4 illustrates a timing diagram 400 useful in understanding the operation of memory controller 300 of FIG. 3 when using adaptive cross-mode thresholding. In timing diagram 400, the horizontal axis represents time in nanoseconds (ns), and the vertical axis is dimensionless but shows streaks of read and write commands from among commands in command queue 220. These streaks include a first streak 410, a second streak 420, a third streak 430, and a fourth streak 440. Shown in timing diagram 400 are four time points of interest, labelled “t₁”, “t₂”, “t₃”, and “t₄”, respectively.

First streak 410 is a read streak, i.e., the current mode is read and the cross mode is write. Memory controller 200 executes read memory commands shown as a block labelled “RD” from among the read and write commands command queue 220. While the read streak continues, command queue 220 accumulates other read and write commands according to the changing mix of memory access requests generated by active software threads. At each command cycle, cross-mode enable logic 248 evaluates whether command queue 220 holds a number of cross-mode commands that exceeds an adaptive read-to-write threshold, labelled “XMW_{TH}”. Cross-mode enable logic 248 counts the number of write requests in command queue 220 among the set of reads and writes shown in FIG. 4 as the cross-hatched area. When the number of writes gets large enough, cross-mode enable logic 248 decides to switch to the cross mode, i.e., the write mode. At time t₁, arbiter 238 determines that the number of write commands in command queue 220 is greater than or equal to XMW_{TH}, and thus memory controller 200 allows cross-mode activations, in this case, by the issuance of activate commands for write accesses. Between times t₁ and t₂, arbiter 238 also selects low-cost current-mode accesses, in this case read hits in addition to the cross-mode activations. At time t₂, the number of low-cost current-mode accesses falls to zero, e.g., there are no more current-mode page hit commands in command queue 220, causing memory controller 300 to switch to write mode and to start second streak 420. There may be other current-mode commands that are not low-cost because they require overhead commands such as precharges and activates. Arbiter 238 estimates the adaptive threshold so that the time between t₁ and t₂ is sufficient to hide the minimum activate to read or write command delay time, a timing parameter known as “t_{RCD}”, so that when the current mode is set to write mode, timing-eligible write commands are available without stalling memory controller 200. For example, if arbiter 238 sends an activate command for the row of a pending write command at t₁, the pending write command will have satisfied the t_{RCD} parameter by time t₂. Thus, the pending write command will be eligible to be sent to the memory as soon as the write-to-read turn-around takes place at time t₂. When the number of low-cost read page hit commands in command queue 220 reaches zero, then memory controller 200 switches to the cross mode, e.g., the write mode. In response to switching to the write mode, arbiter 238 also takes a snapshot of the number of writes in command queue 220, and uses this snapshot to update the adaptive threshold.

Equation [1] provides a formula for the next adaptive threshold:

$${XMW}_{TH}^{′} = MAX ( MIN\_WRITE \_THRESHOLD , SNAP - OFFSET ) \qquad [ 1 ]$$

wherein XMW_{TH}′ is the next adaptive read-to-write threshold, MIN_WRITE_THRESHOLD is a constant, SNAP is the snapshot, and OFFSET is an offset corresponding to t_{RCD}. The MIN_WRITE_THRESHOLD provides a minimum value for XMW_{TH} in case SNAP-OFFSET is too small. The OFFSET corresponds to a number of commands that memory controller 200 accumulates from which to send cross-mode activates so that it will be able to hide the t_{RCD} parameter during the transition to the cross mode.

Continuing with timing diagram 400, second streak 420 is a streak of write cycles, i.e., the current mode is write and the cross mode is read. Memory controller 200 executes a streak of write memory access requests shown as a block labelled “WR” from command queue 220. The write streak continues while command queue 220 accumulates other read and write commands according to the flow of various program threads. At each command cycle, cross-mode enable logic 248 evaluates whether command queue 220 holds a number of cross-mode commands that exceeds an adaptive write-to-read threshold, labelled “XMRTH”, that was calculated during the previous write-to-read turnaround according to Equation [2]:

$${XMR}_{TH}^{′} = MAX ( MIN\_READ \_THRESHOLD , SNAP - OFFSET ) \qquad [ 1 ]$$

Third streak 430 is a streak of read cycles, i.e., the current mode is read and the cross mode is write. Memory controller 200 executes a streak of read memory access requests from command queue 220. The read streak continues while command queue 220 accumulates other read and write commands according to the flow of various program threads. At each command cycle, cross-mode enable logic 248 evaluates whether command queue 220 holds a number of cross-mode commands that exceeds the adaptive read-to-write threshold XMW_{TH} that was calculated during the previous write-to-read turnaround according to Equation [1]. At time t₃, arbiter 238 determines that the number of write commands in command queue 220 is greater than or equal to the cross-mode read-to-write threshold. Between times t₃ and t₄, arbiter 238 selects low-cost current-mode accesses, in this case read page hits, as well as cross-mode activates. When the number of low-cost current-mode accesses, in this case read page hits, falls to zero, then at time t₄, memory controller 300 switches to write mode. Arbiter 238 estimated the adaptive threshold so that the time between t₃ and t₄ is sufficient to hide the cross-mode ACT to cross-mode CAS delay, i.e., t_{RCD}, based on the snapshot of the number of writes at the previous read-to-write turn-around. When the number of current-mode low-cost page hit commands in command queue 220 reaches zero, then memory controller 200 switches to the cross mode, e.g., the write mode. In response to switching to the write mode, arbiter 238 also takes a snapshot of the number of writes in command queue 220, and uses this snapshot to update the adaptive threshold XMW_{TH} for use during the next read-to-write turn-around.

Arbiter 238 adapts the thresholds (XMW_{TH} and XMRTH) generally to start sending cross-mode activate commands neither too early (in which case it impacts current-mode efficiency), nor too late (in which case it is not able to prepare enough timing-eligible cross mode page hits to fully hide t_{RCD}). The “right” time, i.e., a time that it neither too early nor too late, is estimated ahead of time during the previous turn-around between the same two modes by assuming that most of the time, the host processor's workloads change only slowly over time. In the illustrated implementation, the OFFSET is a static number based on t_{RCD} and other timing parameters and reflects how aggressively memory controller 140 will be in starting cross-mode activations. In other implementations, the OFFSET could be calculated differently.

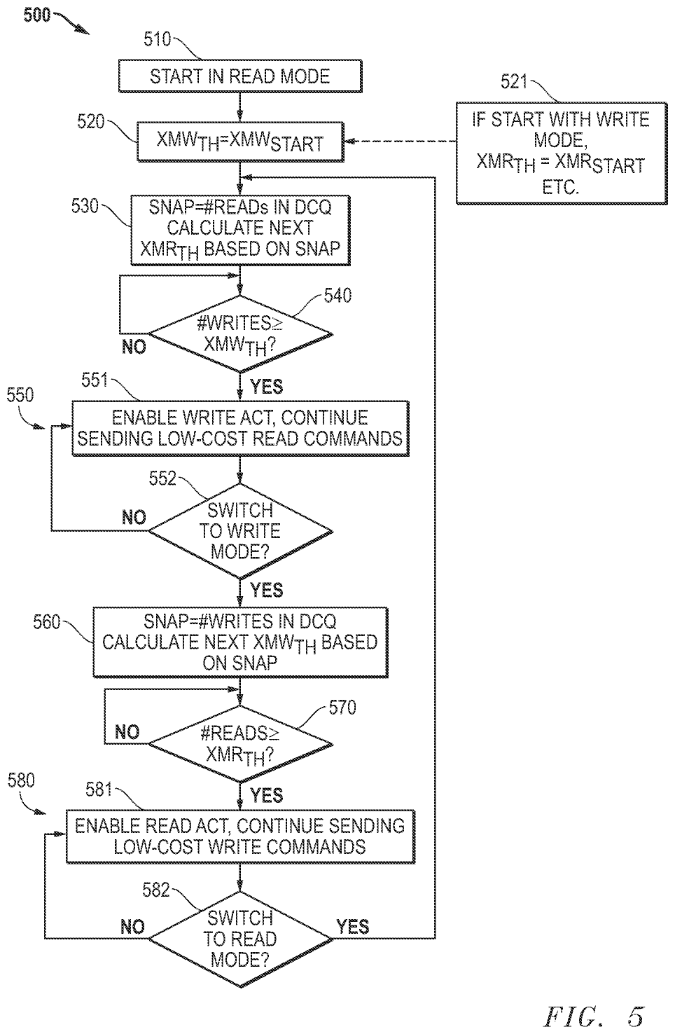

FIG. 5 illustrates a flow chart 500 useful in understanding the operation of the adaptive cross-mode memory selection technique disclosed herein according to some implementations. Flow starts at an action box 510, for example, after startup in read mode. In an action box 520, the value XMW_{TH} is set to a respective starting value labelled “XMW_{START}”. Alternatively, flow could start in write mode, and in an action box 521, the value XMRTH is set to a respective starting value labelled “XMR_{START}”, and the read and write flow shown further in FIG. 5 would be reversed.

In an action box 530, a snapshot is taken of the number of read cycles in command queue 220 to form the variable SNAP. On startup until the number of read cycles increases with instruction execution, the value of XMRTH will be set by the minimum value.

In a decision box 540, arbiter 238 determines whether the number of cross-mode accesses, in this case writes, in command queue 220 exceeds XMW_{TH}. If not, then flow returns to decision box 540, and arbiter 238 again calculates and the number of writes in command queue 220 exceeds XMW_{TH} at the next command cycle.

If so, then flow proceeds to a decision loop 550. Decision loop 550 includes an action box 551 and a decision box 552. In action box 551, arbiter 238 enables write activates while continuing to send low-cost read page hit commands. Decision box 552 determines whether to switch to write mode by determining whether there are any low-cost reads, e.g., read hits, remaining in command queue 220. If not, then flow return to action box 551.

If so, then in an action box 560, arbiter 238 takes a snapshot of the number of writes in command queue 220, and calculates the next XMW_{TH} based on the SNAP according to equation [1] above.

In a decision box 570, arbiter 238 determines whether the number of cross-mode accesses, in this case reads, in command queue 220 exceeds XMRTH. If not, then flow returns to decision box 570, and arbiter 238 again calculates whether the number of reads in command queue 220 exceeds XMRTH at the next command cycle.

If so, then flow proceeds to a decision loop 580. Decision loop 580 includes an action box 581 and a decision box 582. In action box 581, arbiter 238 enables read activates while continuing to send low-cost write page hit commands. Decision box 582 determines whether to switch to read mode by determining whether there are any low-cost writes, e.g., write page hits, remaining in command queue 220. If not, then flow return to action box 581. If so, however, arbiter 238 switches to read mode, and in response, flow returns to action box 530 in which a new SNAP is taken with which to update XMRTH.

Thus, a memory controller data processing system, and method have been disclosed that use an adaptive cross-mode threshold to determine when to enter a cross mode. When the decision to enter the cross mode has been made, the memory controller begins sending cross-mode activates in order to have timing-eligible cross-mode commands available to issue without stalling the memory controller when the mode is switched. Cross-mode enable logic circuitry adapts the threshold by taking a snapshot of the number of cross mode commands present in the command queue. Thus, the adaptive threshold is able to change with the workload of accesses in the memory controller.

While particular implementations have been described, various modifications to these implementations will be apparent to those skilled in the art. For example, the cross-mode enable and adaptive threshold techniques can be applied to read-to-write cross-mode transitions and to write-to-read cross-mode transitions. Other types of streaks can be ended or continued according to these techniques. While the exemplary implementation used an arbiter 238 that paired a page hit command with a page miss or page conflict command, in other implementations, a single arbiter or more than three sub-arbiters can be used. The present disclosure contemplates a variety of different ways or formulae for adapting the cross-mode threshold in addition to the exemplary command disclosed herein. For example, the adaptive cross-mode threshold could be based on a snapshot of the number of low-cost current mode page hits, or some combination of the number low-cost current mode accesses and the number of cross-mode accesses.

Accordingly, it is intended by the appended claims to cover all modifications of the disclosed implementations that fall within the scope of the disclosed implementations.

1. A memory controller, comprising:
a command queue for receiving memory access requests; and
an arbiter operable to:
allow cross-mode activations during a streak of accesses of a current mode in response to a number of cross-mode accesses present in the command queue exceeding an adaptive threshold of cross-mode accesses present in the command queue exceeding an adaptive threshold.

2. The memory controller of claim 1, wherein:
the current mode comprises one of a read mode and a write mode; and
the cross mode comprises another one of the read mode and the write mode.

3. The memory controller of claim 1, wherein:
the arbiter subsequently switches to a cross mode in response to a number of current-mode low-cost accesses being zero.

4. The memory controller of claim 3, wherein in response to switching to the cross mode, the arbiter is further operable to:
take a snapshot of the number of cross-mode accesses in the command queue; and
modify the adaptive threshold according to the snapshot to form a next adaptive threshold.

5. The memory controller of claim 4, wherein the arbiter is further operable to:
allow the cross-mode activations during a subsequent streak of accesses of the current mode in response to a subsequent number of cross-mode accesses present in the command queue exceeding the next adaptive threshold.

6. The memory controller of claim 4, wherein the arbiter is further operable to:
select a plurality of cross-mode activate commands starting a predetermined offset before changing from the current mode to the cross mode, wherein the predetermined offset is based on at least one memory timing parameter; and
change to the cross mode when the command queue no longer stores any low-cost current-mode page hit commands.

7. The memory controller of claim 4, wherein the arbiter modifies the adaptive threshold further based on:
a minimum cross-mode threshold, wherein the minimum cross-mode threshold is a constant; and
a difference between the snapshot and an offset, wherein the offset corresponds to a time that hides an overhead of changing to the cross mode and the offset is based on at least one memory timing parameter.

8. A data processing system, comprising:
a data processor;
a memory;
a memory controller coupled to the data processor and the memory, comprising:
a command queue for receiving memory access requests; and
an arbiter operable to:
allow cross-mode activations during a streak of accesses of a current mode in response to a number of cross-mode accesses present in the command queue exceeding an adaptive threshold.

9. The data processing system of claim 8, wherein:
the current mode comprises one of a read mode and a write mode; and
the cross mode comprises another one of the read mode and the write mode.

10. The data processing system of claim 8, wherein:
the arbiter subsequently switches to a cross mode in response to a number of current-mode low-cost accesses being zero.

11. The data processing system of claim 10, wherein in response to switching to the cross mode, the arbiter is further operable to:
take a snapshot of the number of cross-mode accesses in the command queue; and
modify the adaptive threshold according to the snapshot to form a next adaptive threshold.

12. The data processing system of claim 11, wherein the arbiter is further operative to:
determine to allow the cross-mode activations during a subsequent streak of accesses of the current mode in response to a subsequent number of cross-mode accesses present in the command queue exceeding the next adaptive threshold.

13. The data processing system of claim 11, wherein the arbiter is further operable to:
select a plurality of cross-mode activate commands starting a predetermined offset before changing from the current mode to the cross mode, wherein the predetermined offset is based on at least one memory timing parameter; and
change to the cross mode when the command queue no longer stores any low-cost current-mode page hit commands.

14. The data processing system of claim 11, wherein the arbiter modifies the adaptive threshold further based on:
a minimum cross-mode threshold, wherein the minimum cross-mode threshold is a constant; and
a difference between the snapshot and an offset, wherein the offset corresponds to a time that hides an overhead of changing to the cross mode.

15. A method for use in a memory controller, comprising:
selecting current-mode memory access requests from a command queue and sending them to a memory interface queue that causes them to be transmitted over a allowing cross-mode activations during a streak of accesses of a current mode in response to a number of cross-mode accesses in the command queue exceeding an adaptive threshold; and
subsequently entering a cross mode.

16. The method of claim 15, wherein:
the current mode comprises one of a read mode and a write mode; and
the cross mode comprises another one of the read mode and the write mode.

17. The method of claim 15, further comprising:
taking a snapshot of the number of cross-mode accessed in the command queue; and
modifying the adaptive threshold according to the snapshot to form a next adaptive threshold.

18. The method of claim 17, further comprising:
allowing the cross-mode activations during a subsequent streak of accesses of the current mode in response to a subsequent number of accesses in a cross mode present in the command queue exceeding the next adaptive threshold.

19. The method of claim 17, wherein the selecting comprises:
selecting a plurality of cross-mode activate commands starting a predetermined offset before changing from the current mode to the cross mode, wherein the predetermined offset is based on at least one memory timing parameter; and
changing to the cross mode when the command queue no longer stores low-cost current-mode page hit commands.

20. The method of claim 17, wherein modifying the adaptive threshold comprises modifying the adaptive threshold based on:
a minimum cross-mode threshold, wherein the minimum cross-mode threshold is a constant; and
a difference between the snapshot and an offset, wherein the offset corresponds to a time that hides an overhead of changing to the cross mode.
